(19) United States
(12) Patent Application Publication
(10) Pub. No.: US 2006/0058911 A1
(43) Pub. Date: Mar. 16, 2006

(54) System and method for phase monitoring during blow molding

(75) Inventor: Robert Schnabel, Loganville, PA (US)

Correspondence Address: VENABLE LLP, P.O. BOX 34385, WASHINGTON, DC, 20045-9998, US

(73) Assignee: Graham Packaging Company, L.P., York, PA (US)

(21) Appl. No.: 10/938,643

(22) Filed: Sep. 13, 2004

(51) Int. Cl. B29C 49/78

(52) U.S. Cl. 700/197; 264/40.1; 264/40.6

(57) ABSTRACT

A system and method for monitoring the phase of the manufacturing process for a blow molded container. Once a parison is initially programmed, the wall thickness of the produced containers is monitored on a real time basis during production. The measured thickness profile is compared continually to the thickness profile as originally programmed. If the process is out of phase, the magnitude of the discrepancy is determined. In an embodiment of the invention, an operator is informed as to whether or not the process is in phase. If the process is not in phase, the operator is informed of the extent to which the process is out of phase. This information can be conveyed to the operator through a computer display, for example. The operator can then adjust the programming as necessary.

### BACKGROUND OF THE INVENTION

1. Field of the Invention

The present invention relates generally to the manufacture of plastic containers, and more particularly to control of the manufacturing process.

2. Related Art

Plastic containers, such as HDPE bottles, can be produced on high speed molding machines. As shown in FIG. 1, a high speed molding machine 100 can have a rotary wheel 112 for carrying a series of adjacent molds 114 and 116. Molds 114 and 116 can have a top tail section and a bottom tail section. When molds 114 and 116 are positioned on rotary wheel 112, the top tail section of mold 114 is adjacent to the bottom tail section of adjacent preceding mold 116. Molds 114 and 116 can have mold halves. The mold halves can attach to rotary wheel 112 by vertical support members, sometimes referred to as plattens (not shown).

A parison (not shown) can be formed by upwardly extruding a thermoplastic material and positioning the parison between separated mold halves of each mold of rotary wheel 112. The mold halves are then closed around the parison and air is injected into the parison. Inside each mold, the parison expands and presses the outer surface of the parison against the inner surface of the mold to form the plastic container. When the plastic container thusly formed cools, the mold is opened and the plastic container is ejected from the mold.

In high speed molding machines, there can be more than one container forming cavity in a mold, each cavity being fed with a parison. Where two container forming cavities are present in a single mold, each cavity can be in line with a separate parison injector. In this case, each cavity is fed by a different parison. This two cavity blow molding system is known as a dual parison blow molding system. Moreover, each cavity in a dual parison blow molding system can be used to form more than one connected container. For example, if each cavity forms two connected containers, each mold will produce four containers per mold when the two connected containers from each cavity are separated. When each cavity forms a pair of containers, the pair of connected containers ejected from the mold is known as a log.

Any particular container design is defined by a number of parameters. These parameters define the size and shape of the product. While the outer shape of a container is determined by the shape of the mold, the thickness of the container wall at various points is determined by “programming” the parison. When a programmed parison is taken up via mold, and then injected with air as described above, the result is a container having particular thicknesses at different points in the container wall as determined by the programmed parison. The thickness of the container wall at different points in the container is referred to herein as a thickness profile of the container.

One of the manufacturing problems in the process described above is the accuracy of the programming. In particular, a programmed parison should result in a container that has the desired thickness at particular points in the fabricated container. If, for example, it is desired that a container be fabricated with a certain wall thickness at a point two inches from the base, the parison must be programmed to have the appropriate thickness at the appropriate point in the parison wall, such that the molded container will have the desired thickness at this point. If the parison is not programmed properly, the desired thickness may appear at a different point in the finished product. Therefore, instead of having a certain thickness at a point two inches from the base, the container may, for example, have that thickness one and one half inches from the base, or two and one half inches from the base. If the parison is programmed to have certain wall thicknesses at different points in the parison such that the resulting container has the desired thickness profile, then this process is said to be “in phase”. If the programming of the parison results in containers that have a thickness profile that is misaligned by some distance, the process is said to be out of phase.

Determining whether a process is in or out of phase has traditionally been done on a trial and error basis. This process was known as “throwing a pin.” This term is a throwback to the times when container manufacturing was controlled strictly by mechanical means. Programming a parison was performed by placing each of an array of pins in a particular location in a control board. Each pin represented a specific point on the parison and therefore represented a particular point on the finished container. Placing a pin all the way to one side of the control board would result in a corresponding location of the parison (and, therefore, a corresponding location of the container) having the least possible wall thickness. Analogously, placing the pin all the way to the other side of the control board would give the associated point of the parison (and, therefore, the corresponding point of the finished container) the maximum possible wall thickness. Throwing a pin meant that the pin was placed all the way to the left or all the way to the right on the control board. After the container was fabricated, the container would be examined and the thick (or thin) location would be found. If the spot corresponded to the location on the container that was believed to correspond to the thrown pin, then the process was deemed to be in phase.

This process is illustrated by FIG. 2. The process begins at step 210. In step 220, a pin is selected. In step 230, the pin is thrown to the extreme left or the extreme right of the control board. In step 240, the log or container is molded. In step 250, the thin or thick spot on the container that resulted from the pin thrown in step 230 is located. In step 260, a determination is made as to whether the location of that spot corresponds to the location associated with the thrown pin. If so, then the manufacturing process was considered to be in phase. If not the process was considered to be out of phase. By throwing a pin, therefore, the point on the container controlled by the thrown pin is determined. If the pin actually controls the thickness at a location other than what was previously believed, the programming of the parison needs to be adjusted in an effort to alter and correct the phase.

Examples of containers resulting from the pin-throwing process are shown in FIGS. 3A and 3B. A pin corresponding to location 310 has been thrown to create a thick point at a location that is a distance dₚ from the base of container 300. The thick point has thickness TMAX. If the process is in phase, container 300 is produced, as shown in FIG. 3A.

FIG. 3B shows a container that is out of phase. The thrown pin creates the thick spot at location 360, not at location 310. The thick spot is found at a distance dm from the base of the container, such that dₘ=dₚ+Δd. Because the thrown pin apparently corresponds to location 360, and not location 310, reprogramming is necessary.

While this method solves the problem as to whether a manufacturing process was in or out of phase, the pin throwing process is wasteful. Because trial and error is involved, at least one log or container is typically wasted, e.g., the containers of FIGS. 3A and 3B. Moreover, time is lost as well. The process of FIG. 2 represents an experimental approach to determining whether a manufacturing process was in or out of phase. Multiple trials could be necessary before the programming is finally corrected. What is needed, therefore, is a phase detection method and system that is less wasteful and that provides phase information quickly and cheaply.

### SUMMARY OF THE INVENTION

The invention described herein is a system and method for monitoring the phase of the manufacturing process for a blow molded container. Once the parison is initially programmed, the wall thickness of the produced containers is monitored on a real time basis during production. The measured thickness profile is compared continually to the thickness profile as originally programmed. If the process is out of phase, the magnitude of the discrepancy is determined. In an embodiment of the invention, an operator is informed as to whether or not the process is in phase. If the process is not in phase, the operator is informed of the extent to which the process is out of phase. This information can be conveyed to the operator through a computer display, for example. The operator can then adjust the programming as necessary.

Further features and advantages, as well as the structure and function of preferred embodiments will become apparent from a consideration of the following description, drawings, and examples.

### BRIEF DESCRIPTIONS OF THE FIGURES

The foregoing and other features and advantages of the invention will be apparent from the following, more particular description of the invention, as illustrated in the accompanying drawings.

FIG. 1 illustrates an example of apparatus for the manufacture of blow molded plastic containers.

FIG. 2 is a flow chart that illustrates a process by which the phase of a blow molding process can be determined.

FIGS. 3A and 3B illustrate examples of containers produced during phase determination.

FIG. 4 is a flow chart that illustrates the processing of an embodiment of the invention.

FIGS. 5A and 5B illustrate containers produced by processes that are in phase and out of phase, respectively.

FIG. 6 illustrates the placement of a thermocoupled strip in a mold cavity, according to an embodiment of the invention.

FIG. 7 is a data flow diagram illustrating the determination of phase information and its display, according to an embodiment of the invention.

FIG. 8 illustrates how such a display may look to an operator, according to an embodiment of the invention.

FIG. 9 illustrates the computing context of the invention, according to an embodiment thereof.

FIG. 10 is a flow chart that illustrates the processing of an embodiment of the invention in which a parison is reprogrammed automatically.

FIG. 11 is a data flow diagram illustrating the determination of phase information and the automatic reprogramming of a parison, according to an embodiment of the invention.

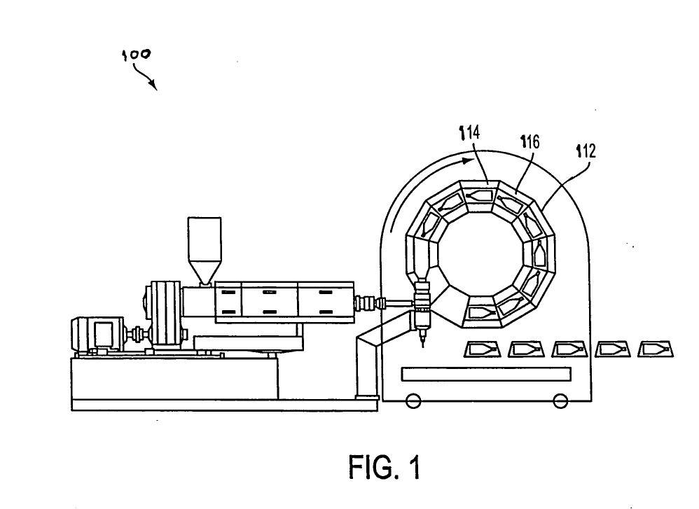

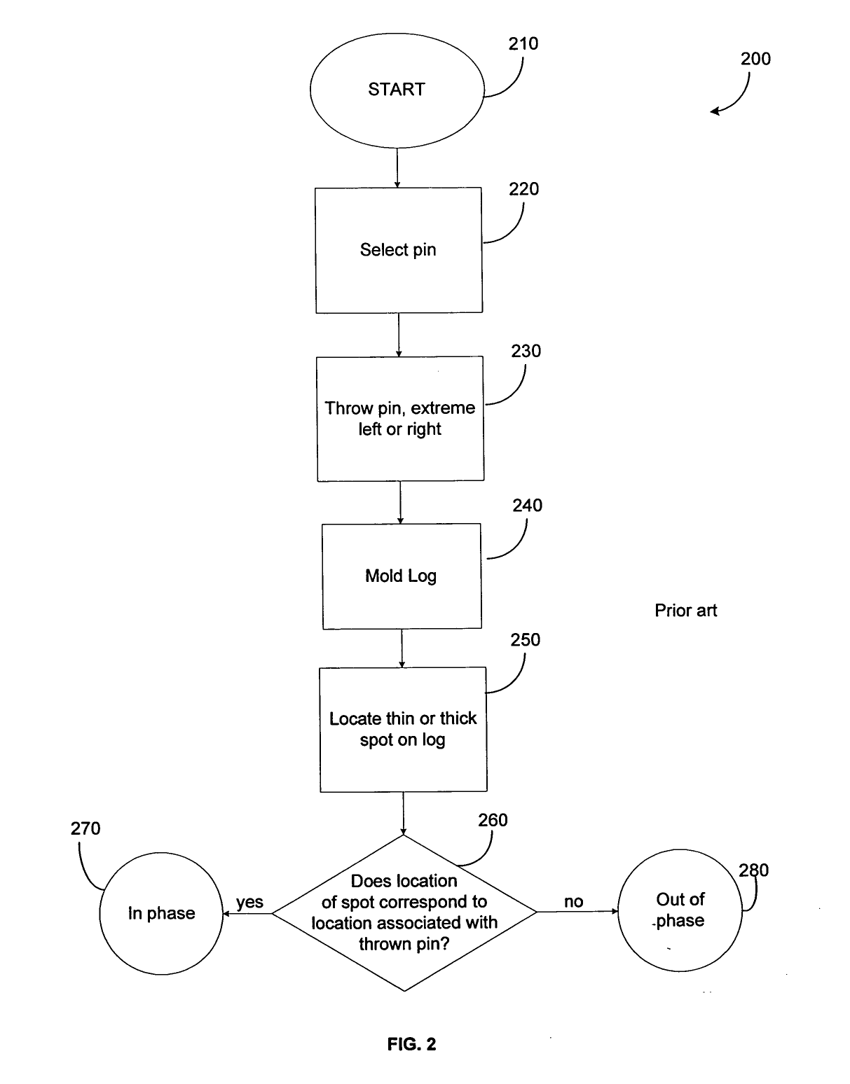

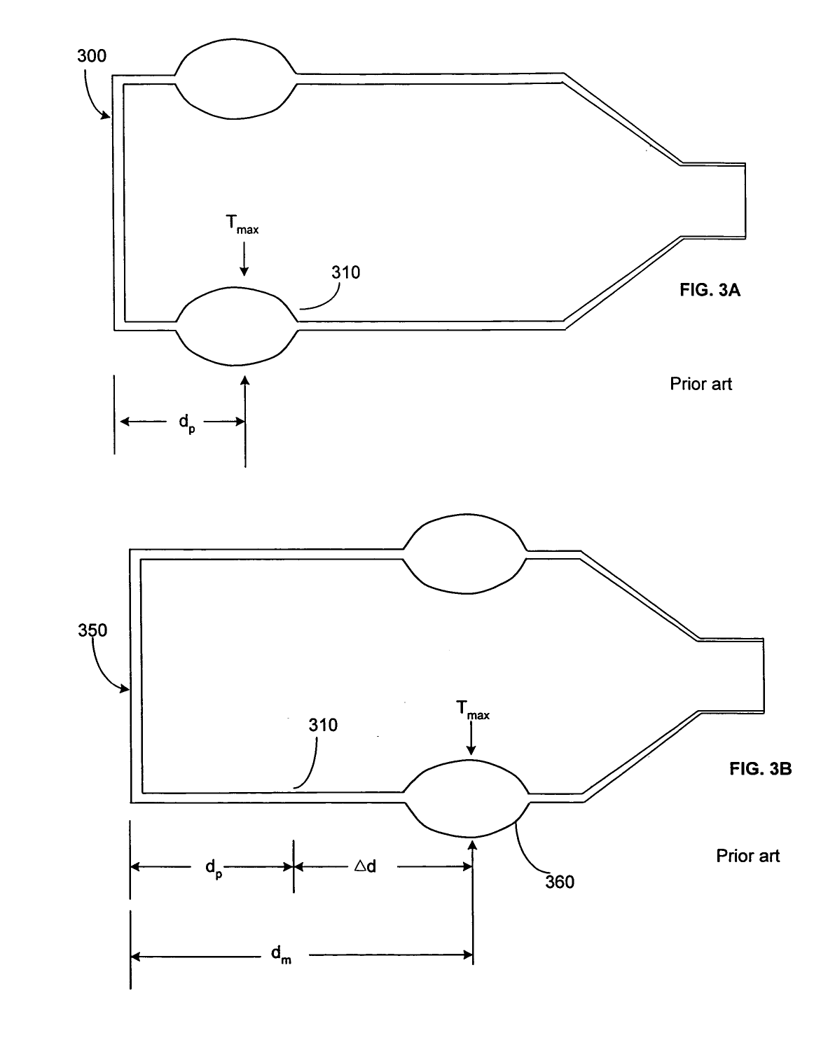

### DETAILED DESCRIPTION

The invention described herein is a system and method for monitoring the phase of the manufacturing process for a blow molded container. Once the parison is initially programmed, the wall thickness of the produced containers is monitored on a real time basis during production. The measured thickness profile is compared continually to the thickness profile as originally programmed. If the process is out of phase, the magnitude of the discrepancy is determined. In an embodiment of the invention, an operator is informed as to whether or not the process is in phase. If the process is not in phase, the operator is informed of the extent to which the process is out of phase. This information can be conveyed to the operator through a computer display, for example. The operator can then adjust the programming as necessary.

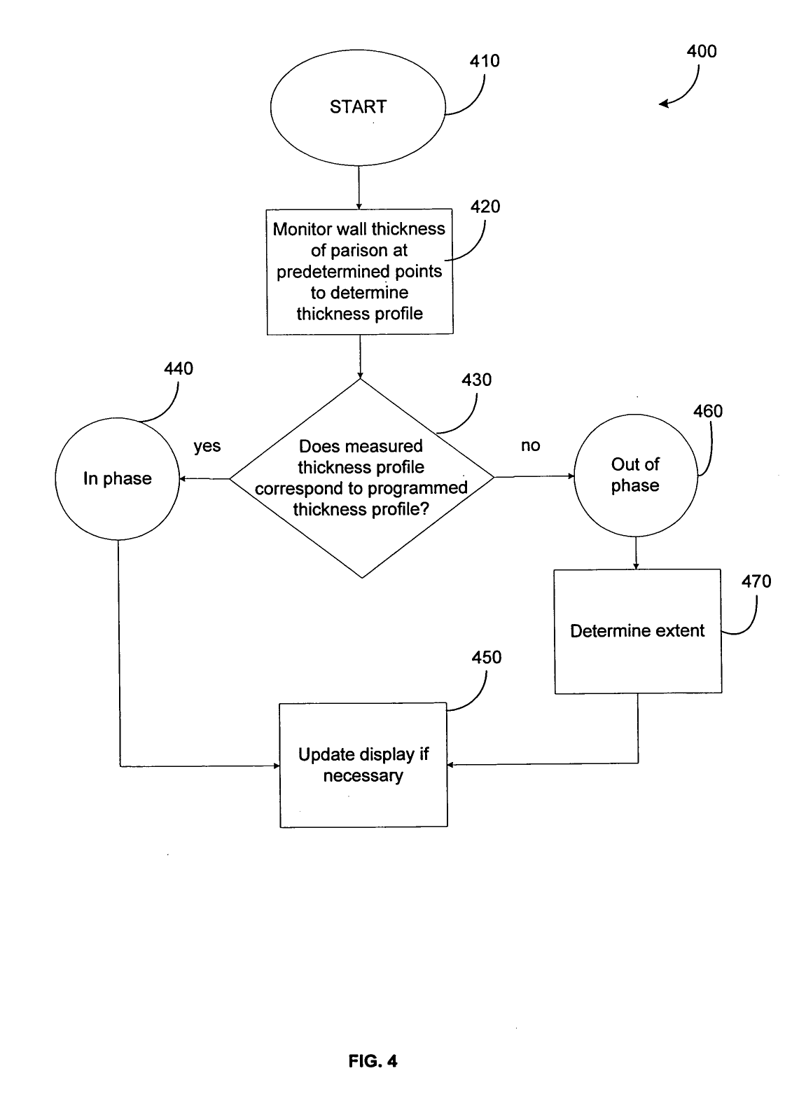

The processing of an embodiment of the invention is illustrated generally in FIG. 4. The process begins at step 410. At step 420, the wall thickness of a parison is monitored as the parison is being molded into a log or container. In the illustrated embodiment, wall thickness is monitored from a plurality of predetermined points in the mold cavity. Measurements from these predetermined points are used to determine a measured thickness profile for the log. The determination of wall thickness will be described in greater detail below. In step 430, a determination is made as to whether the measured thickness profile corresponds to the thickness profile that has been programmed. This represents a determination of whether the wall thickness at various points in the log or container accurately reflects the programming. If the measured thickness profile coincides with the programmed thickness profile, then the process is determined to be in phase, as illustrated in state 440. If the measured thickness profile does not correspond to the programmed thickness profile, then a determination is made that the process is out of phase, as illustrated by state 460. If the manufacturing process is out of phase, then in step 470 the extent to which the process is out of phase is determined. In step 450, the results of the phase monitoring process are used to update an output device, such as an operator display as necessary. If the phase is unchanged, then there is no need to update the display. If the phase has changed, then this information must be conveyed to the operator, and the display is updated accordingly.

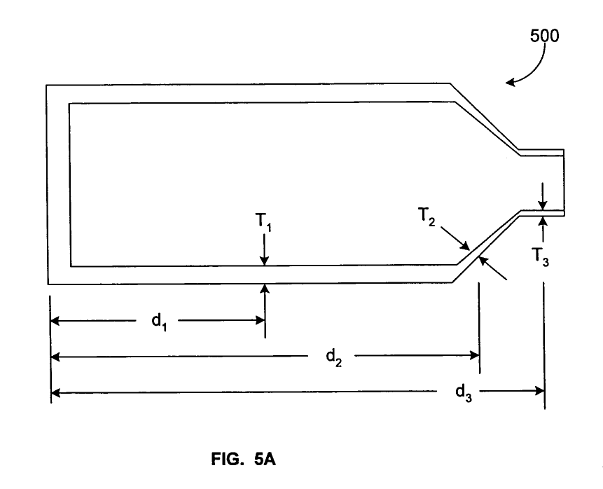

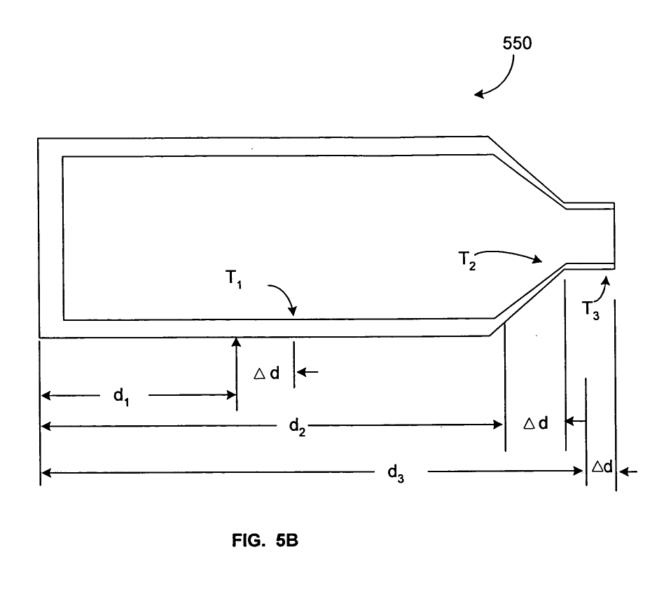

The difference between a programmed thickness profile and a measured thickness profile is illustrated in FIGS. 5A and 5B. Container 500, shown in FIG. 5A, is the result of a manufacturing process that is in phase. The parison had been programmed to yield a container having a wall thickness T₁ at a distance d₁ from the base of the container. Similarly, the parison was programmed such that the resulting container would have a wall thickness T₂ at a point that is a measured distance d₂ from the base of the container. Likewise, the parison was programmed such that the resulting container would have thickness T₃ at a distance d₃ from the base of the container. This correlation of thicknesses to locations on the container wall represents a thickness profile. The container illustrated in FIG. 5A has a thickness profile as programmed, given that the process which produced it was in phase. While the illustrated profile identifies three points, a profile may contain more than three points.

In contrast, FIG. 5B illustrates a container 550 that has been produced by a process that is out of phase. Here, the parison has been programmed to produce a container as shown in FIG. 5A. Although the parison was programmed to create a container having a thickness T₁ at a location d₁, the position having thickness T₁ has been displaced by a distance Δd. Similarly, thickness T₂ has been displaced an equal amount from intended location d₂. Likewise, thickness T₃ is found at a distance that is beyond the intended location d₃. Again, the displacement is indicated by the distance Δd. In this case, the thickness profile as measured does not correspond to the programmed thickness profile illustrated in FIG. 5A. The process is therefore out of phase. Referring to FIG. 4, this discrepancy would be discovered in step 430 as a result of monitoring the wall thickness in step 420. Because the manufacturing process is determined to be out of phase, the extent to which the process is out of phase is determined in step 470. In the illustration of FIG. 5B, the manufacturing process is out of phase by a distance Δd.

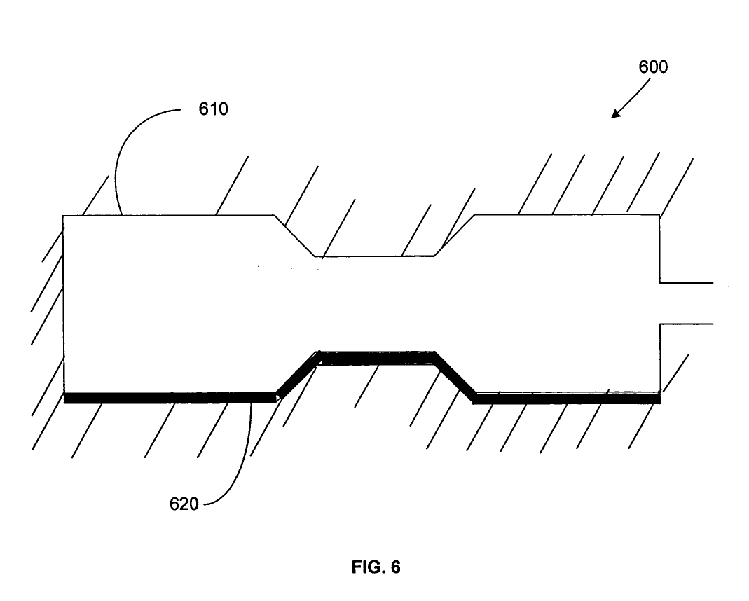

Determining a measured thickness profile requires the monitoring of the wall thickness of a log or container at a number of points in the mold cavity. In an embodiment of the invention, this measurement is achieved by the use of a thermocouple strip. This is illustrated in FIG. 6. A mold cavity 610 is shown having a thermocouple strip 620 running the length of cavity 610. The thermocouple strip detects variations in heat through the length of mold cavity 610. After the parison has been placed in mold cavity 610, air is injected to create the interior space of the log or container. The molten plastic material of the parison is thereby pressed against the interior of mold cavity 610. At any given time in the cooling process, the amount of heat present at a point in the log wall can be detected by thermocouple strip 620. Generally, the thickness at a point in the wall represents a local mass of plastic. If the mass is greater, the amount of heat present in the local mass is likewise greater. Hence, greater thickness at a point in the wall corresponds to a higher temperature at that point. A measured thickness profile can therefore be determined by measuring the temperature at various points in thermocouple strip 620.

While the apparatus 600 shown in FIG. 6 illustrates a single continuous thermocouple strip, in an alternative embodiment of the invention, a series of discrete thermocouple sensors can be placed along the length of mold cavity 610. In such an apparatus, temperature (and therefore wall thickness) is measured at a set of discrete points in the cavity 610. In yet another embodiment of the invention, a plurality of thermocouple strips can be employed and placed along the length of mold cavity 610. Such an arrangement would have the benefit of generating a larger number of thickness measurements. This would improve the accuracy of a measured thickness profile. This arrangement would also have the benefit of protection against the failure of any single thermocouple strip.

In an embodiment of the invention, each mold of a fabrication apparatus includes one or more thermocouple sensors. This would allow continual monitoring of phase. In alternative embodiments, some subset of the mold cavities include one or more thermocouple sensors.

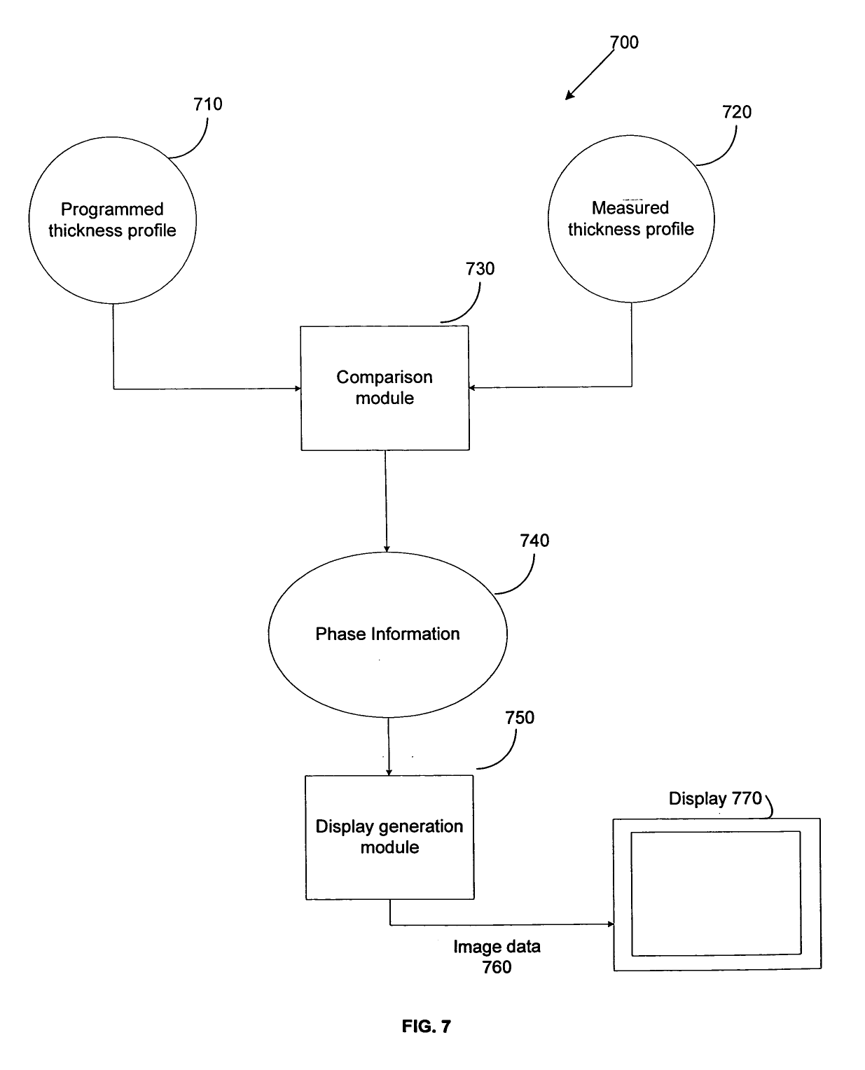

The invention is further illustrated by the embodiment shown in FIG. 7. FIG. 7 illustrates some of the processing modules that can be used in this embodiment. A programmed thickness profile is illustrated as data 710. Similarly, a measured thickness profile is shown as data 720. Data 710 and 720 are entered into a module 730 that compares the two bodies of data. By comparing the two, a determination is made as to whether the profiles coincide, and whether, therefore, the manufacturing process is in phase. The output of comparison module 730 is phase information 740. This information represents an indication as to whether or not the process is in phase. If the process is not in phase, phase information 740 further comprises an indication of the degree to which the manufacturing process is out of phase. Phase information 740 is sent to display generation module 750. Display generation module 750 represents logic with which phase information 740 can be converted for output to an output device. In the illustrated embodiment, the output device is a visual display. Module 750 can therefore comprise hardware and/or software for rendering a computer graphics image, for example. The output of display generation module 750 is image data 760. Data 760 represents a signal which is sent to the output device, display 770, to generate an image that serves as an indicator to an operator as to whether the manufacturing process is in phase.

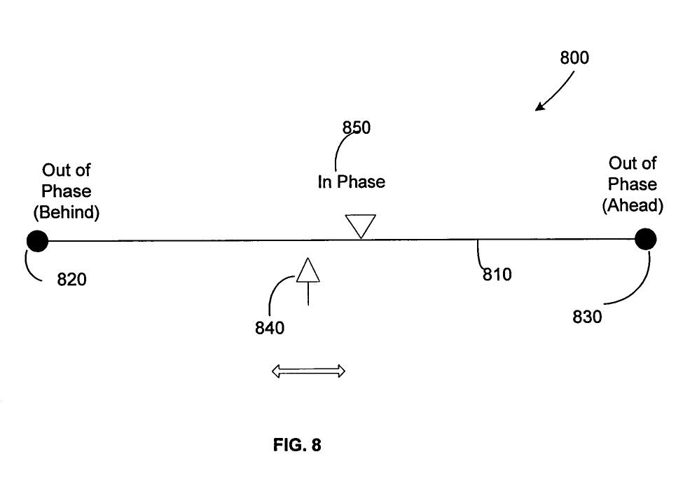

An example of such an image is shown in FIG. 8. In this embodiment of the invention, the displayed image includes a line or bar 810. The leftmost point of line 810 is shown as point 820. The rightmost point of line 810 is point 830. An indicator arrow 840 is positioned at some point between points 820 and 830. The position of indicator 840 indicates whether the manufacturing process is in phase or out of phase, and if the process is out of phase, shows the extent to which the process is out of phase. If indicator 840 points to point 820, the process is fully out of phase in one direction. If indicator 840 points to point 830, the process is fully out of phase in the opposite direction. Depending on the extent to which the manufacturing process is out of phase, indicator 840 will point to the appropriate spot on line 810. In the event that the manufacturing process is in phase, indicator 840 will point to the center point of line 810. In the illustrated embodiment, this point is shown as icon 850. As the phase of the manufacturing process is repeatedly determined, the image 800 would likewise be repeatedly updated. With each update, indicator 840 would potentially point to a different spot on line 810. If, for example, the manufacturing process begins in phase but slowly drifts out of phase, then indicator 840 would begin under icon 850, but would slowly move to either the left or the right. Hence, image 800 would show not only the extent to which a manufacturing process may be out of phase but would also indicate the direction and rate at which the phase is changing.

In an alternative embodiment of the invention, the phase may instead be represented on a computer display as a radial dial, similar in appearance to an analog speedometer in an automobile. In such an embodiment, the needle would point to some location on the radius of the dial. If the needle were to point to the topmost position of the dial (i.e, “12 o'clock”), this would indicate that the manufacturing process is in phase. If the needle were to drift away from this point, this would be an indication that the manufacturing process is moving out of phase.

In yet another embodiment of the invention, the image could simply be a numeric value. Such a numeric value would represent a measure of the extent to which the manufacturing process is out of phase. A zero would indicate that the manufacturing process is in phase. A nonzero positive number would indicate that the process is out of phase in one direction. The magnitude of the number would correlate to the extent to which the process is out of phase. Similarly, a negative number would indicate that the manufacturing process is out of phase in the opposite direction. Again, the magnitude of the negative number would indicate the extent to which the manufacturing process is out of phase.

Certain features of the present invention may be implemented using hardware, software or a combination thereof and may be implemented in one or more computer systems or other processing systems. In one embodiment, the invention may comprise one or more computer systems capable of carrying out the functionality described herein. In particular, the comparison of measured and programmed thickness profiles (module 730 of FIG. 7) may be implemented using a computer system. The generation of a display for the operator (module 750 of FIG. 7) may also be implemented using the same or a different computer system.

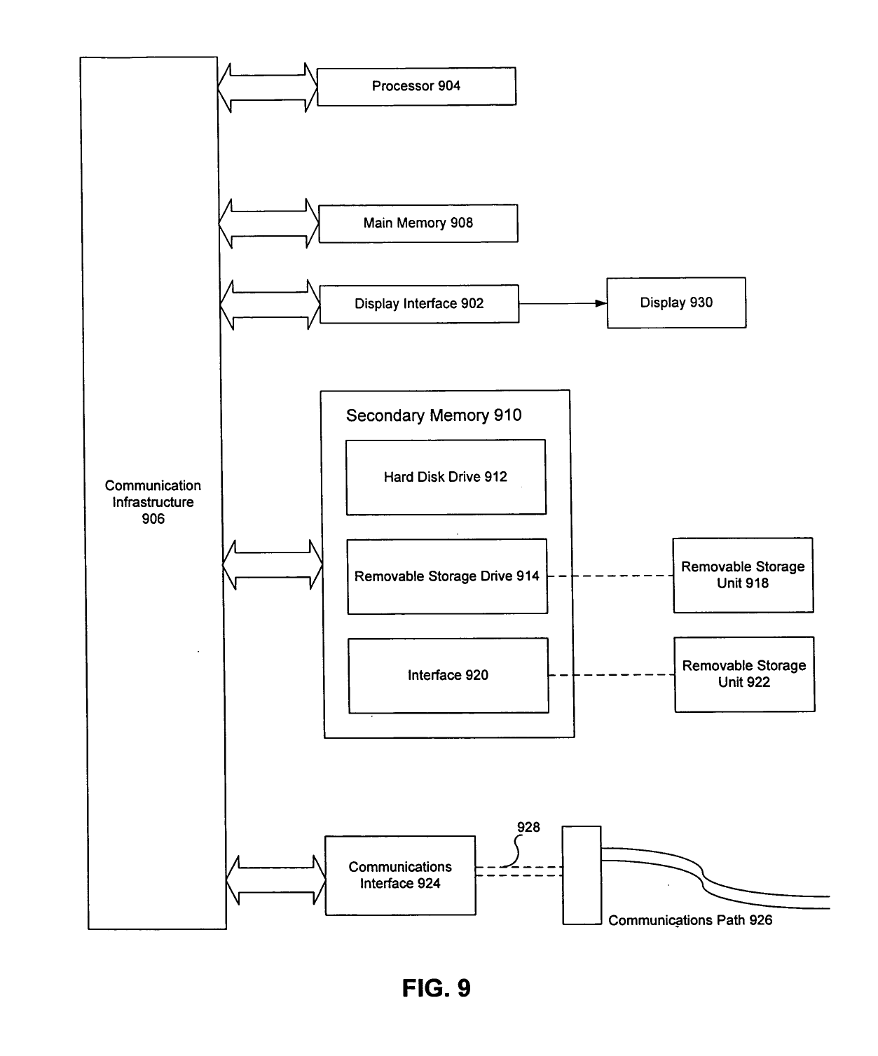

An example of a computer system 900 is shown in FIG. 9. The computer system 900 may include one or more processors, such as processor 904. The processor 904 may be connected to a communication infrastructure 906 (e.g., a communications bus or network). Various software embodiments are described in terms of this exemplary computer system. After reading this description, it will become apparent to a person skilled in the relevant art(s) how to implement the invention using other computer systems and/or computer architectures.

Computer system 900 may include a display interface 902 that may forward graphics, text, and other data from the communication infrastructure 906 for display on the display unit 930.

Computer system 900 may also include a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc, but which is not limited thereto. The removable storage drive 914 may read from and/or write to a removable storage unit 918 in a well known manner. Removable storage unit 918, may represent a floppy disk, magnetic tape, optical disk, etc. which may be read by and written to by removable storage drive 914. As will be appreciated, the removable storage unit 918 may include a computer usable storage medium having stored therein computer software and/or data.

In alternative embodiments, secondary memory 910 may include other similar means for allowing computer programs or other instructions to be loaded into computer system 900. Such means may include, for example, a removable storage unit 922 and an interface 920. Examples of such may include, but are not limited to, a removable memory chip (such as an EPROM, or PROM) and associated socket, and/or other removable storage units 922 and interfaces 920 that may allow software and data to be transferred from the removable storage unit 922 to computer system 900.

Computer system 900 may also include a communications interface 924. Communications interface 924 may allow software and data to be transferred between computer system 900 and external devices. Examples of communications interface 924 may include, but are not limited to, a modem, a network interface (such as an Ethernet card), a communications port, a PCMCIA slot and card, etc. Software and data transferred via communications interface 924 are in the form of signals 928 which may be, for example, electronic, electromagnetic, optical or other signals capable of being received by communications interface 924. These signals 928 may be provided to communications interface 924 via a communications path (i.e., channel) 926. This channel 926 may carry signals 928 and may be implemented using wire or cable, fiber optics, an RF link and/or other communications channels.

In this document, the terms “computer program medium” and “computer usable medium” are used to generally refer to media such as, but not limited to, removable storage drive 914, a hard disk installed in hard disk drive 912, and signals 928. These computer program media are means for providing software to computer system 900.

Computer programs (also called computer control logic) may be stored in main memory 908 and/or secondary memory 910. Computer programs may also be received via communications interface 924. Such computer programs, when executed, enable the computer system 900 to perform the features of the present invention as discussed herein. In particular, the computer programs, when executed, may enable the processor 904 to perform the present invention in accordance with the above-described embodiments. Accordingly, such computer programs represent controllers of the computer system 900.

In an embodiment where the invention is implemented using software, the software may be stored in a computer program product and loaded into computer system 900 using, for example, removable storage drive 914, hard drive 912 or communications interface 924. The control logic (software), when executed by the processor 904, causes the processor 904 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). As discussed above, the invention can be implemented using any combination of hardware, firmware and software.

In an additional embodiment of the invention, the process of the invention can be further automated, so that reprogramming of a parison can be done automatically, without direct operator intervention. In such an embodiment, a measured thickness profile is compared to a programmed thickness profile. If the two profiles do not correspond, the manufacturing process is determined to be out to phase, and the extent of the disparity between the profiles is determined. The extent of the disparity is then used as feedback to automatically reprogram the parison and thereby adjust the phase of the manufacturing process.

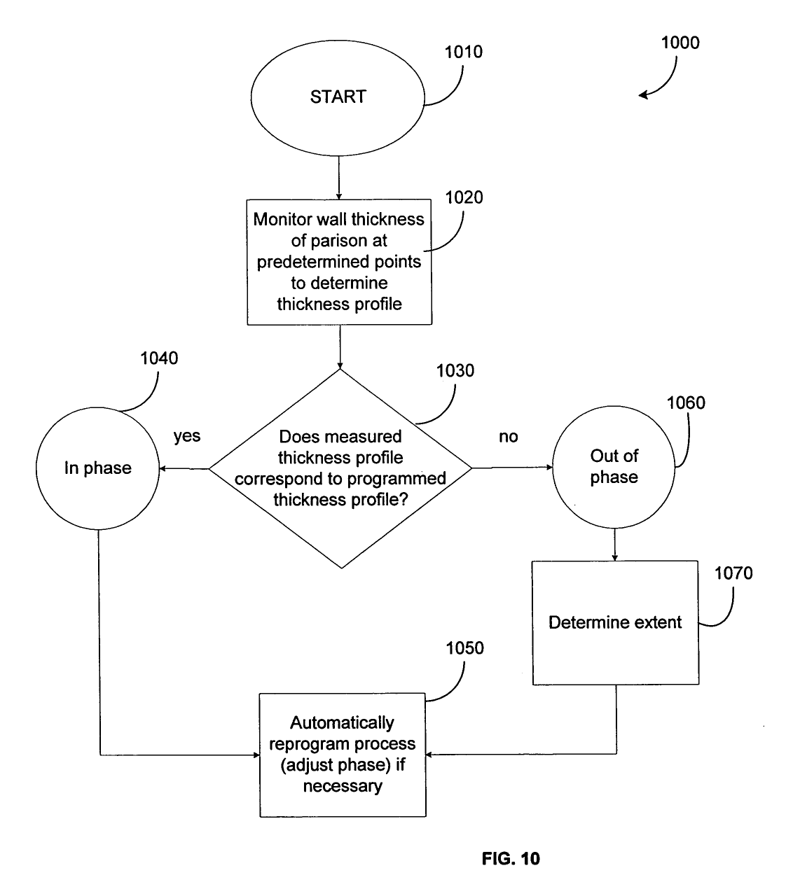

This process is illustrated in greater detail in FIG. 10. The process begins at step 1010. At step 1020, the wall thickness of a parison is monitored as the parison is being molded into a log or container. In the illustrated embodiment, wall thickness is monitored from a plurality of predetermined points in the mold cavity. Measurements from these predetermined points are used to determine a measured thickness profile for the log. In step 1030, a determination is made as to whether the measured thickness profile corresponds to the thickness profile that has been previously programmed. This represents a determination of whether the wall thickness at various points in the log or container accurately reflects the programming. If the measured thickness profile coincides with the programmed thickness profile, then the process is determined to be in phase, as illustrated in state 1040. If the measured thickness profile does not correspond to the programmed thickness profile, then a determination is made that the process is out of phase, as illustrated by state 1060. If the manufacturing process is out of phase, then in step 1070 the extent to which the process is out of phase is determined. In step 1050, the results of the phase monitoring process are used as feedback to automatically reprogram the parison, thereby adjusting the phase of the manufacturing process, as necessary. The reprogramming can be done without operator intervention in an embodiment of the invention. The extent of the phase adjustment performed in step 1050 is determined by step 1070. Note that any phase change can be conveyed to an operator through an I/O device, such as a display, in an embodiment of the invention. The processing of FIG. 10 can be implemented as programmable logic that is stored and executed on a system such as that illustrated in FIG. 9.

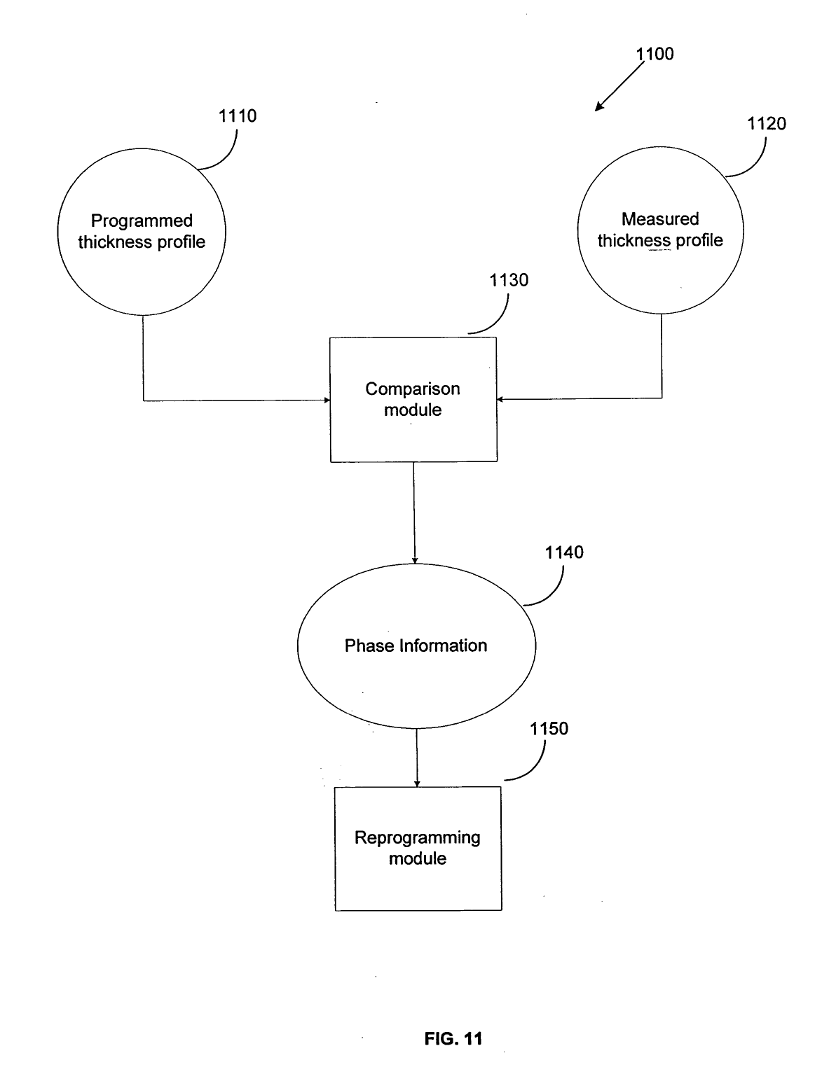

The embodiment of FIG. 10 is further illustrated in FIG. 11, which illustrates some of the processing modules that can implement this embodiment. A programmed thickness profile is illustrated as data 1110. Similarly, a measured thickness profile is shown as data 1120. Data 1110 and 1120 are entered into a module 1130 that compares the two bodies of data. By comparing the two, a determination is made as to whether the profiles coincide, and whether, therefore, the manufacturing process is in phase. The output of comparison module 1130 is phase information 1140. This information represents an indication as to whether or not the process is in phase. If the process is not in phase, phase information 1140 further comprises an indication of the degree to which the manufacturing process is out of phase. Phase information 1140 is sent to reprogramming module 1150. Here the parison is automatically reprogrammed to adjust the phase of the manufacturing process. The extent of the phase adjustment is based on phase information 1140. Reprogramming module 1150 can be implemented as programmable logic that is stored and executed on a system such as that illustrated in FIG. 9.

While various embodiments of the present invention have been described above, it should be understood that they have been presented by way of example, and not limitation. It will be apparent to persons skilled in the relevant art that various changes in form and detail can be made therein without departing from the spirit and the scope of the invention.

We claim:

1. A method of monitoring the phase of a blow-molding process, comprising:
a. programming a parison to create a programmed thickness profile;
b. during molding, monitoring wall thickness of the parison at a plurality of predetermined points to create a measured thickness profile;
c. comparing the programmed thickness profile with the measured thickness profile;
d. if the programmed thickness profile and the measured thickness profile correspond, identifying the molding process as being in phase;
e. otherwise, identifying the molding process as being out of phase.

2. The method of claim 1, wherein said step b. comprises monitoring the temperature of the parison at the plurality of predetermined points.

3. The method of claim 1, further comprising:
f. determining the extent to which the molding process is out of phase.

4. The method of claim 3, further comprising:
g. informing an operator as to whether the molding process is out of phase.

5. The method of claim 4, further comprising:
h. informing the operator of the extent to which the process is out of phase.

6. The method of claim 4, wherein the operator is informed through a graphical display.

7. The method of claim 1, wherein the parison is reprogrammed if the molding process is identified as out of phase.

8. The method of claim 1, wherein the parison is reprogrammed automatically, without operator intervention, based on the extent to which the molding process is out of phase.

9. The method of claim 1, wherein steps b through e are repeated for the blow molding of each of a plurality of parisons.

10. A system for determining the phase of a process for blow-molding a container, the system comprising:
a thickness detection means for measuring, during molding, a wall thickness of the container at a plurality of predetermined locations;
comparison logic for comparing the locations of measured thicknesses with the locations of programmed thicknesses; and
an output device that outputs the results of said comparison logic.

11. The system of claim 10, wherein said thickness detection means comprises a thermocouple strip, inside a mold of the container, wherein said strip measures temperature at said predetermined locations.

12. The system of claim 10, wherein said thickness detection means comprises a plurality of thermocouple sensors that measure temperature at said predetermined locations, respectively.

13. The system of claim 10, wherein said output device shows whether the molding process is out of phase.

14. The system of claim 13, wherein said output device further shows the extent to which the molding process is out of phase.

15. The system of claim 10, wherein said output device is updated if the phase changes.

16. The system of claim 10, wherein said output device comprises a computer display.

17. The system of claim 10, further comprising reprogramming means for automatically reprogramming a parison on the basis of the extent to which the molding process is out of phase.

18. A computer program product comprising a computer usable medium having computer readable program code means embodied in said medium for causing an application program to execute on a computer that compares a programmed thickness profile and a measured thickness profile, said computer readable program code means comprising:
a first computer readable program code means for causing the computer to receive the programmed thickness profile;
a second computer readable program code means for causing the computer to receive the measured thickness profile;
a third computer readable program code means for causing the computer to compare the programmed and measured thickness profiles; and
a fourth computer readable program code means for causing the computer to produce phase information based on the comparison of the programmed and measured thickness profiles.

19. The computer program product of claim 18, further comprising:
a fifth computer readable program code means for causing the computer to produce image data based on the phase information.

20. The computer program product of claim 18, further comprising:
a fifth computer readable program code means for causing the computer to automatically reprogram a parison on the basis of the phase information.
